(19) United States
(12) Patent Application Publication
(10) Pub. No.: US 2026/0103968 A1
(43) Pub. Date: Apr. 16, 2026

(54) SYSTEMS AND METHODS FOR DETECTING OR MONITORING SUBSURFACE EVENTS USING CONTINUOUS WAVELET TRANSFORMS

(71) Applicant: University of Houston System, Houston, TX (US)

(72) Inventors: Mohamed Y. Soliman, Cypress, TX (US); Mohamed A. Gabry Abdelsalam, Houston, TX (US); Ibrahim Eltaleb, Houston, TX (US); S. M. Farouq Ali

(73) Assignee: University of Houston System, Houston, TX (US)

(21) Appl. No.: 19/116,624

(22) PCT Filed: Sep. 29, 2023
(86) PCT No.: PCT/US2023/075629

§ 371 Date: Mar. 28, 2025

Related U.S. Application Data
(60) Provisional application No. 63/412,269, filed on Sep. 30, 2022.

(51) Int. Cl. E21B 43/26; G01V 1/50

(52) U.S. Cl. CPC E21B 43/26; G01V 1/50; E21B 2200/20; G01V 2210/1299; G01V 2210/48

(57) ABSTRACT

A computer-implemented method for detecting or monitoring subsurface events includes receiving a data signal obtained from a subsurface region, and performing a continuous wavelet transform whereby a continuous wavelet is superimposed on the received data signal to determine one or more wavelet transform coefficients. The method further includes determining a signal energy from the one or more wavelet transform coefficients at a plurality of distinct scales, and detecting an occurrence of a subsurface event based on the signal energy.

### CROSS-REFERENCE TO RELATED APPLICATIONS

This application claims benefit of U.S. provisional patent application Ser. No. 63/412,269 filed Sep. 30, 2022 and entitled “Systems and Methods for Monitoring Subsurface Events Using Continuous Wavelet Transforms,” which is hereby incorporated herein by reference in its entirety for all purposes.

### STATEMENT REGARDING FEDERALLY SPONSORED RESEARCH OR DEVELOPMENT

Not applicable.

### BACKGROUND

Well systems are utilized for a variety of purposes including, among other things, for the extraction of hydrocarbons or other materials from a subsurface region for establishing geothermal power systems, and for storing materials (e.g., carbon dioxide or other greenhouse gasses) within the subsurface region. Various operations may be conducted via a well system including, for example, drilling into the subsurface region to extend a longitudinal length of a wellbore of the well system, completing a drilled wellbore to place the wellbore in condition for producing materials (e.g., hydrocarbons) from the subsurface region, and injecting fluids into the wellbore such as for long-term storage as part of a carbon capture and sequestration system. One or more planned or unplanned subsurface events (e.g., an event within the subsurface region) may occur during the performance of such well system operations. In addition, the rapid and accurate detection of such subsurface events is, in at least some instances, advantageous in conducting the respective well system operation.

### BRIEF SUMMARY OF THE DISCLOSURE

An embodiment of a computer implemented method for detecting or monitoring subsurface events comprises receiving a data signal obtained from a subsurface region; performing a continuous wavelet transform whereby a continuous wavelet is superimposed on the received data signal to determine one or more wavelet transform coefficients; determining a signal energy from the one or more wavelet transform coefficients at a plurality of distinct scales; and detecting an occurrence of a subsurface event based on the signal energy. In some embodiments, the method further comprises determining an average signal energy for all of the plurality scales. In other embodiments, the method comprises detecting the occurrence of a subsurface event based on the determined average signal energy. In some embodiments, the plurality of distinct scales of the one or more wavelet transform coefficients is across a predefined range. In some embodiments, the continuous wavelet comprises a complex wavelet. In some embodiments, the plurality of distinct scales extends between 0.1 to 256. In some embodiments, detecting an occurrence of a subsurface event based on the signal energy, comprises comparing the signal energy with the received data signal. In other embodiments, detecting an occurrence of a subsurface event based on the signal energy, comprises identifying a point in time at which the signal energy achieves a stabilized minimum energy level. In some embodiments, the subsurface event corresponds to a closure of a hydraulic fracture extending from a wellbore penetrating the subterranean region. In other embodiments, the signal comprises a pressure signal corresponding to a wellbore pressure. In some embodiments, performing a continuous wavelet transform comprises determining wavelet transform coefficients for all the plurality scales across a predefined range. In some embodiments, detecting an occurrence of a subsurface based on the signal energy, comprises determining a time at which the subsurface event occurred. In some embodiments, detecting an occurrence of a subsurface based on the signal energy, comprises determining a magnitude of the data signal at a moment in time at which the subsurface event occurred. In some embodiments, the method comprises creating a scalogram of the signal energy at the plurality of distinct scales. In some embodiments, the one or more wavelet transform coefficient is determined in accordance with the following equation:

$$T ( a , b ) = \frac{1}{\sqrt{a}} {\int }_{- ∞}^{∞} x ( t ) {ψ}^{*} ( \frac{t - b}{a} ) d t$$

where (T(a, b)) represents a continuous wavelet transform, (x(t)) represents the received signal,

$$( {ψ}^{*} ( \frac{t - b}{a} ) )$$

represents a mother wavelet function, (t) represents time, (a) represents scale parameter, and (b) represents position parameter
In some embodiments, the method further comprises determining one or more wavelet transform moduli from a one or more wavelet transform coefficient; and determining the signal energy from the one or more wavelet transform moduli. In some embodiments, an embodiment of a system for detecting or monitoring subsurface events, comprises a computer comprising one or more processors; and one or more memory devices coupled to the one or more processors storing program instructions including an event detection module that when executed by the one or more processors, cause the one or more processors to receive a data signal obtained from a subsurface region; perform a continuous wavelet transform whereby a continuous wavelet is superimposed on the received data signal to determine one or more wavelet transform coefficients; and determine a signal energy from the one or more wavelet transform coefficients at a plurality of distinct scales. In some embodiments, the program instructions including the event detection module, when executed by the one or more processors, cause the one or more processors to detect an occurrence of a subsurface event based on the signal energy. In some embodiments, the system further comprises a sensor in signal communication with the event detection module, the sensor configured to produce the data signal received by the event detection module. In some embodiments, the program instructions including the event detection module, when executed by the one or more processors, cause the one or more processors to determine an average signal energy for all of the plurality scales.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of exemplary embodiments of the disclosure, reference will now be made to the accompanying drawings in which:

FIGS. 1 and 2 are schematic diagrams of an embodiment of a well system;

FIG. 3 is an example of a wellbore pressure response obtained from an injection test;

FIG. 4 is an example graph depicting the convolution of an exemplary signal with a continuous wavelet;

FIG. 5 is a graph depicting an exemplary complex continuous wavelet;

FIG. 6 is a graph depicting the exemplary complex continuous wavelet of FIG. 5 with a different scale;

FIG. 7 is an illustration of the mechanism of wavelet transform;

FIGS. 8-11 are examples of the most common wavelets used in continuous wavelet transform;

FIG. 12 is an example plot of the scalogram of signal energy analysis;

FIG. 13 is an example plot of the average of the log signal energy of all scales illustrates an image formed using a pair of angular spectral filters in accordance with principles disclosed herein;

FIG. 14 is an example plot of the average of all log signal energies at several wavelet scales;

FIG. 15 illustrates fracture closure using Continuous Wavelet Transform (CWT) closure detection technique in accordance with principles disclosed herein;

FIG. 16 is a block diagram of an example computing system that may perform operations in accordance with principles disclosed herein;

FIG. 17 is a flowchart illustrating an embodiment of a method for detecting or monitoring subsurface events in accordance with principles disclosed herein; and

FIGS. 18 and 19 are graphs illustrating validation of systems and methods described herein in accordance with principles disclosed herein.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness. In addition, unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Further, as used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

### Introduction

As described above, well systems are utilized to perform various operations for a variety of purposes including for the extraction of desired materials and for the injection and long-term storage of unwanted materials like greenhouse gasses. The performance of well system operations may in at least some instances result in the occurrence of one or more subsurface events in a subterranean earthen formation. Such subsurface events may be planned in some applications and unplanned in other applications. In either event, the rapid and accurate detection of subsurface events is advantageous, if not critical, for the success of the respective well system operation in at least some instances.

As an example, in some applications a wellbore of a respective well system may be tested to estimate one or more geo-mechanical properties of a subterranean earthen formation of the well system such as, for example, a minimum horizontal stress of the earthen formation. Particularly, the minimum horizontal stress of the earthen formation may be estimated by initially pumping a limited volume of fluid into the wellbore to form a small fracture within the earthen formation extending into the earthen formation from the periphery of the wellbore.

Following the pumping of the fluid into the wellbore to form a fracture in the earthen formation, the wellbore may be shut-in or sealed (e.g., downhole or at the surface) whereby pressure within the wellbore is permitted to decline over time as fluid within the wellbore penetrates the newly formed fracture and finally into the formation. At some point during this process, the newly formed fracture closes (the closure of the fracture comprising a subsurface event) under the effect of the stress (minimum horizontal stress that will be approximated as the fracture closure stress) as fluid pressure within the wellbore (and hence within the fracture) continues to decline. The wellbore pressure associated with the closure of the fracture formed in the earthen formation is commonly referred to as the “fracture closure pressure.” The fracture closure pressure generally corresponds to the average of the minimum principal stress for the portion of the subsurface region covered by the newly formed fracture. Once estimated, the minimum principal stress (e.g., the minimum horizontal stress) may be used, for example, in the construction of geo-mechanical models of the earthen formation, designing hydraulic fractures, and designing drilling schedules.

Significant debates surround the various methodologies used to determine fracture closure pressure given that the hydraulic fracture propagation and closure process is fairly complicated due to the formation stress state, presence of natural fractures, heterogeneity, and anisotropy of the properties of the earthen formation. Conventional closure detection methods necessarily rely on pre-set assumptions to simplify the state of the earthen formation. In such conventional methods, the detected fracture closure may become confused with the formation pressure response following the fracture closure. In addition, the pressure change propagates in the earthen formation and produces behavior that may become confused with fracture closure detection.

Fracture closure pressure is defined as the pressure at which a fracture closes, however, the process can be very complex leading to incorrect interpretation. There have been many attempts to detect the contact pressure when the two fracture faces first contact with one another based on the assumption that the fracture closure pressure does not necessarily exist if there is an aperture between the opposing fracture faces. In many cases, analysts attempt various methods to figure out the range of the fracture closure pressure.

Generally, conventional methods for estimating fracture closure pressure rely on limiting and sometimes unrealistic simplifying assumptions. Each of the conventional methods detects the fracture closure from a specific point of view with certain built-in assumptions. This disclosure introduces innovative methods for detecting subsurface events, including detecting fracture closure whereby the fracture closure pressure may be estimated using a wavelet transform technique without reliance on built-in assumptions on how the fracture should behave as commonly done in conventional methods.

Particularly, this disclosure relates to systems and methods that utilize continuous wavelet transforms in the monitoring and detection of subsurface events. Embodiments disclosed herein include an event detection module executable by a computer system and configured to receive one or more data signals associated with a subsurface region such as a subterranean earthen formation, and to perform a continuous wavelet transform on the received data signals to determine one or more wavelet transform coefficients (WTCs). As used herein, the term “data signal” refers to signals indicative of a measured parameter such as pressure, temperature, acoustic or seismic data, and the like. Systems for the monitoring and detection of subsurface events disclosed herein may, in addition to the event detection module and any computer systems on which the module is executed, may include one or more sensors configured to measure one or more corresponding parameters associated with the subsurface region such as, for example, pressure sensors, temperature sensors, etc.

In some embodiments, the event detection module of embodiments disclosed herein may perform a continuous wavelet transform to determine one or more WTCs using a continuous wavelet such as, for example, a complex wavelet such as a Morlet wavelet. Complex wavelets include both real and imaginary parts, and generally respond only to non-negative frequencies of a particular data signal to thereby produce a less oscillatory transform than in the case of real wavelets and thus outperforms real wavelets in detecting and monitoring instantaneous frequencies. The event detection module may additionally determine a signal energy using the WTCs a plurality of distinct scales extending in a predefined range, for example, 0.1 to 256. The convolution of data signal with the complex Morlet wavelet which acts as a mathematical microscope, will results complex WTCs. The wavelet transform modulus (WTM) can be obtained by calculating the modulus of the complex WTCs. Finally, Signal energy for that range can be obtained using the WTM (e.g., representable as log signal energy) of the data signal. This workflow can be used to detect all features of the data signal. The event detection module may additionally obtain an average signal energy of the signal for all scales in the predefined range. In some embodiments, the event detection module may further identify or detect the occurrence of a specific subsurface event based on the obtained average signal energy of the signal. Particularly, the event detection module may identify the achievement of a final stabilized energy level in the average signal energy which corresponds to the occurrence of the specific subsurface event. Alternatively, personnel of systems described herein may identify the occurrence of the dominant specific subsurface event based on the average energy signal obtained by the event detection module.

Various types of subsurface events may be monitored or detected using the continuous wavelet transforms described herein. As one example, the subsurface event may comprise the closure of a hydraulic fracture extending from a wellbore penetrating the subsurface region. In this example, the received signal comprises a pressure signal corresponding to a wellbore pressure. In some embodiments, systems for monitoring subsurface events may comprise both the sensor used to monitor the subsurface region as well as a computer system used to execute the continuous wavelet transform; however, in other embodiments, the system may comprise the computer system but not the sensor. In this example, the event detection module performs a continuous wavelet transform on the received pressure signal, ultimately determining the average signal energy of the pressure signal across a range of scales. The average signal energy may be compared with the pressure signal over time in order to identify the point in time at which the subsurface fracture closure occurs. The point in time at which the subsurface fracture occurs may correspond to the point in time at which the pressure signal achieves a stabilized minimum energy level. The comparison between the pressure signal and the average signal energy may be performed automatically by the event detection module or manually by a user of the module.

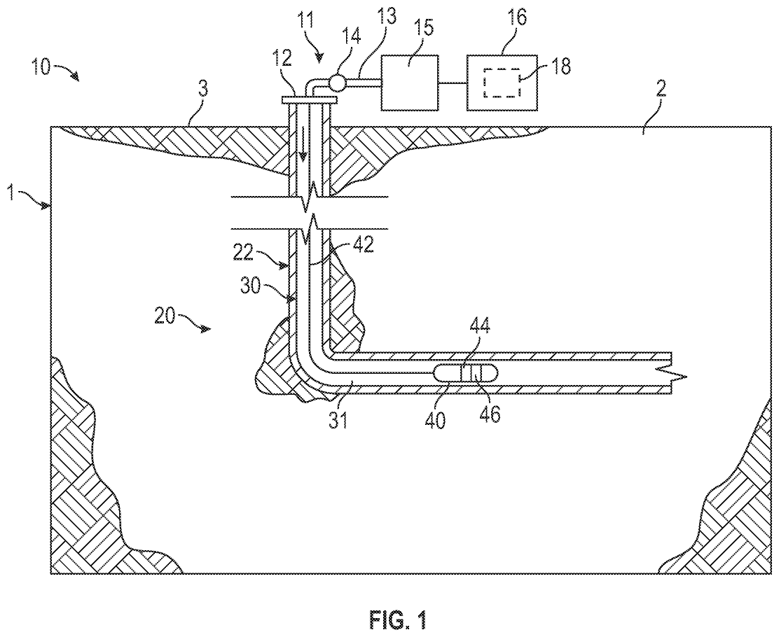

Referring initially to FIG. 1, an embodiment of a well system 10 is shown including a wellbore 22 extending through a subterranean earthen formation 2 of a subsurface region 1. The subterranean earthen formation 2 may include a reservoir that contains hydrocarbons such as oil, gas, etc. For example, the earthen formation 2 may include all or part of a rock formation (e.g., shale, coal, sandstone, or granite) that contains mostly hydrocarbon or water/steam as in case of a geothermal reservoir. The wellbore 22 shown in FIG. 1 includes a deviated or horizontal section extending downhole from a generally vertical section of the wellbore 22. However, in other embodiments, wellbore 22 may comprise horizontal, vertical, slanted, curved, or other orientations or combinations thereof. Well system 10 may be used to ultimately perform one or more different operations including, for example, extraction of materials from the earthen formation 2 and injecting materials into the earthen formation 2. In this exemplary embodiment, well system 10 generally includes an injection system 11 located at a terranean surface 3 of the earthen formation 2, a computer system 16, and a downhole assembly 20 which extends into and through the earthen formation 2. In this exemplary embodiment, injection system 11, is located at the terranean surface 3 and generally includes a wellhead 12, a fluid conduit 13, and a fluid pump 15. The injection system 11 also includes a surface sensor package 14 to measure fluid parameters (e.g., fluid pressure, flow rate, fluid density, temperature, or other parameters) of fluid flowing through the fluid conduit 13.

The fluid pump 15 of the injection system 11 is configured to pressurize fluids at the terranean surface 3 for injection into the wellbore 22 of downhole assembly 20. In this configuration, fluid conduit 13 comprises a discharge conduit extending between the wellhead 12 and a discharge of the fluid pump 15. Thus, the surface sensor package 14 positioned along fluid conduit 13 may monitor the properties of the discharge fluid flow emitted from fluid pump 15. The configuration of fluid pump 15 may vary depending on the given application. For example, fluid pump 15 may comprise reciprocating pumps, centrifugal pumps, and other configurations. In this exemplary embodiment, fluid pump 15 is configured to pressurize an injection fluid to a pressure exceeding the fracturing pressure of the earthen formation 2 whereby one or more fractures may be formed hydraulically in the earthen formation 2 in response to the operation of fluid pump 15.

The computing system 16 may include one or more computing devices or systems located at the terranean surface 3, or in other locations. For example, the computing system 16 or any of its components may be located at a remote data processing center, a computing facility, or another location. In this exemplary embodiment, at least a portion of the computing system 16 is in signal communication with one or more components of injection system 11 and downhole assembly 20 whereby computing system 16 may receive information (e.g., sensor data) provided by one or more sensors of well system 10. Sensor data received by computing system 16 may be captured by one or more surface sensors (e.g., one or more sensors of surface sensor package 14) and/or one or more downhole sensors (e.g., one or more sensors of downhole assembly 20 as will be described further herein. The sensor data used by computing system 16 in detecting or monitoring a subsurface event may comprise data of wellbore 22 (e.g., fluid pressure data, fluid temperature data) or data of earthen formation 2 itself (e.g., acoustic data which has penetrated the earthen formation 2).

Computing system 16 comprises an event detection module 18 for monitoring one or more subsurface events associated with subsurface region 1 using sensor data provided to computing system 16 via one or more sensors of well system 10. Event detection module 18 may allow for the accurate and confident detection (e.g., a detection having a low error rate) of subsurface events which may be critical to the performance of various operations using well system 10. Event detection module 18 may be embodied in instructions stored in one or more non-transitory storage mediums of computing system 16 and which is executed by one or more processors of computing system 16. In some embodiments, event detection module 18 may be used by operators of well system 10 to detect or monitor subsurface events in real-time or near real-time such that this information may be leveraged in the continued performance of a given well operation using well system 10. The failure to detect an expected subsurface event (indicating that the expected subsurface event failed to occur) may similarly be utilized by operators of well system 10 in performing a given well operation. Downhole assembly 20 of well system 10 generally includes a wellbore 22 and a casing string 30 positioned in and affixed to the wellbore 22. Wellbore 22 extends from a first or uphole end located at the terranean surface 3 and a longitudinally opposed second or downhole end located within the earthen formation 2. Similarly, casing string 30 of well system 10 extends from a first or uphole end located proximate to terranean surface 3 (e.g. coupled to wellhead 12) to a second or downhole end located within wellbore 22 beneath the terranean surface 3. In this exemplary embodiment, casing string 30 is secured to a generally cylindrical sidewall of wellbore 22 via cement (or any other suitable material that has been pumped into the annulus formed between an outer surface of casing string 30 and the sidewall of wellbore 22). In this configuration, a flowpath is formed along a central passage 31 of casing string 30 that extends from the terranean surface 3 and into the wellbore 22 formed within earthen formation 2. In some embodiments, casing string 30 may comprise a plurality of steel casing joints that are coupled end-to-end and installed in the wellbore 22 via a drilling system. In other embodiments, well system 10 may not include casing string 30 and wellbore 22 may instead comprise an uncased wellbore. In some embodiments, the casing string 30 may be perforated and/or may include one or more valves (e.g., sliding sleeve valves) positioned along casing string 30 to facilitate the flow of fluids between the earthen formation 2 and the wellbore 22.

In this exemplary embodiment, downhole assembly 20 additionally includes a downhole assembly 40 located within the central passage 31 of casing string 30. Downhole assembly 40 is suspended from a tubular conveyance 42 which may comprise a line (e.g., wireline, slickline) or a cylindrical string (e.g., a workstring, a drillstring). Tubular conveyance 42 extends into the uphole end of casing string 30 and through the central passage 31 thereof to the downhole assembly 40 located therein. In some embodiments, signals and data (e.g., electrical signals) are transportable along tubular conveyance 42 between downhole assembly 40 and components of well system 10 located at the terranean surface 3. For example, tubular conveyance 42 may provide signal communication between downhole assembly 40 and computing system 16. Further, in some embodiments, materials (e.g., fluids) may be transportable through an internal central passage of the tubular conveyance 42.

Downhole assembly 40 may be lowered and transported through the central passage 31 of casing string 30 using the tubular conveyance 42 in conjunction with accompanying surface equipment (e.g., a wireline injector, a drilling or completion rig). Downhole assembly 40 assists in facilitating one or more well operations conducted using well system 10. For example, in some embodiments, downhole assembly 40 may be used to seal the central passage 31 of casing string 30 at a desired location therealong using a downhole seal or plug of downhole assembly 40. Downhole assembly 40 may also be used to form perforations in the casing string 30 using a perforating tool of downhole assembly 40. Downhole assembly 40 may also be used to capture bottomhole information of wellbore 22 such as fluid pressure, temperature, and other parameters of wellbore 22 at downhole locations great distances from the terranean surface 3.

In this exemplary embodiment, downhole assembly 40 generally includes a downhole sensor package 44 and a downhole power source or battery pack 46. Downhole sensor package 44 is deployable into the central passage 31 of casing string 30 to capture bottomhole wellbore data. Particularly, downhole sensor package 44 comprises a pressure sensor configured to monitor pressure within the central passage 31 of casing string 30. Such downhole pressure data may be communicated to computing system 16 via tubular conveyance 42 in some embodiments. In other embodiments, downhole pressure data captured by downhole sensor package 44 may be stored in a non-transitory storage medium or memory device thereof which may be later downloaded to the computing system 16 once downhole assembly 40 has been retrieved to the terranean surface 3.

The downhole sensor package 44 of downhole assembly 40 is powered by the battery pack 46 of downhole assembly 40. In order to extend the battery life of battery pack 46, the sampling rate of downhole sensor package 44 (e.g., the rate or frequency at which downhole sensor package 44 performs one or more measurements, including pressure measurements) may vary in time. For example, the sampling rate of downhole sensor package 44 may decline in response to a given parameter (e.g., fluid pressure within central passage 31 of casing string 30) measured by downhole sensor package 44 remaining relatively stable over time. Conversely, the sampling rate of downhole sensor package 44 may increase in response to a given parameter measured by downhole sensor package 44 becoming unstable or chaotic over time. The sampling rate of downhole sensor package 44 may be increased in response to an increased variance in the measured parameter so as to more completely capture information which may be present within the varying parameter (e.g., information associated with a subsurface event driving such variance in the parameter). Thus, the sampling rate of downhole sensor package 44 may vary continually over time in response to changing conditions within the subsurface region 1.

Referring to FIG. 2, well system 10 is shown following an example injection operation such as an injection test whereby an injection fluid (e.g. water, fracturing fluid) is injected into the earthen formation 2 to obtain information about the subsurface region including the subterranean earthen formation 2, the wellbore 22, or other aspects of the well system 10. For example, during the injection test, injection fluid may be injected into subterranean formation 2 from fluid pump 15 through fluid conduit 13 into wellbore 22 via central passage 31 of casing string 30 into subterranean earthen formation 2. The injection fluid may be pumped into the casing string 30 at a pressure which exceeds the fracture pressure of at least a portion of the subterranean formation 2. This pressurized injection fluid may be communicated to the earthen formation 2 via an opening 4 formed in the casing string 30 (e.g., perforations formed in the casing string 30, open valves positioned along the casing string 30) whereby a fracture 5 is formed hydraulically in the earthen formation. Particularly, fracture 5 formed by the pressurized injection fluid extends outwards from the opening 4 formed in casing string 30 and into the earthen formation 2 whereby a distal end of fracture 5 is spaced radially from the wellbore 22.

While in this exemplary embodiment the injection test initially forms fracture 5, in other embodiments, the injection test may extend or modify existing fractures in the subterranean earthen formation 2. The injection system 11 of well system 10 may apply different injection tests such as, for example, a mini-fracture test, a step-rate test, an in-situ stress test, a pump-in or flowback test, a Diagnostic Fracture Injection Test (DFIT), or other tests. In addition, downhole sensor package 44 of downhole assembly 40 may acquire pressure data from the wellbore 22 (e.g., the pressure within the central passage 31 of casing string 30) during the injection test, and transmit the captured pressure data to computing system 16 where the pressure data may be processed by the event detection module 18 of computing system 16 to detect or monitor one or more subsurface events associated with subsurface region 1. In this exemplary embodiment, event detection module 18 may detect a closure of fracture 5 which occurs towards a conclusion of the injection test.

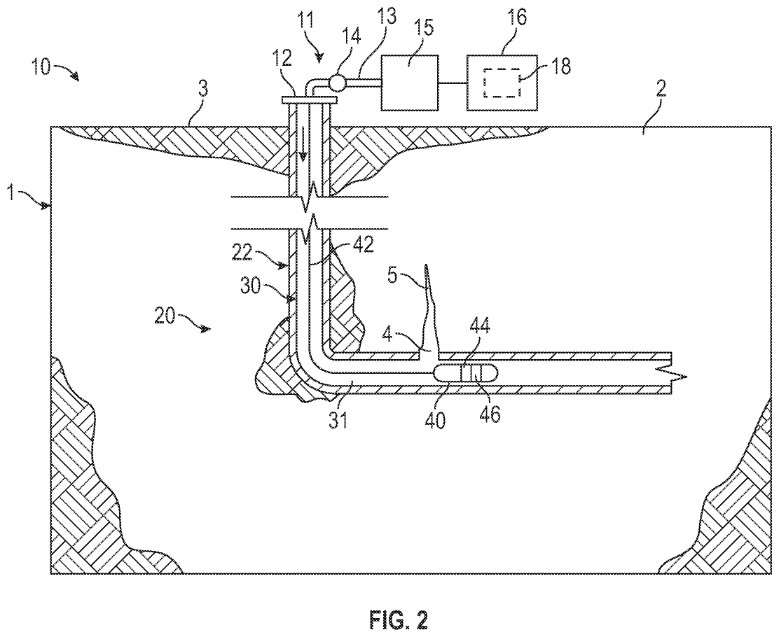

Particularly, and referring to FIGS. 2 and 3, a graph 50 depicting an exemplary wellbore pressure response over time from an injection test, for example, a DFIT, is shown in FIG. 3. Particularly, graph 50 depicts wellbore pressure 51 as captured by the downhole sensor package 44 of downhole assembly 40. As described above, fracture 5 is formed by initially pumping a volume of injection fluid into the wellbore 22 as indicated specifically in graph 50 by a pumping phase 52 of wellbore pressure 51. In this exemplary embodiment, following the creation of fracture 5, the fluid pump 15 is deactivated or shut down such that wellbore pressure 51 gradually declines over time as indicated specifically in graph 50 by the shutdown phase 54 of wellbore pressure 51.

The pressure during the shutdown phase 54 represents the closure process of fracture 5. Injection volumes considered “small” depend on the available shut-in time and size of the earthen formation 2. In this case, pressure and rate change with time are recorded using, for example, downhole sensor package 44, during the stages of the injection test. In this exemplary embodiment, the captured pressure data is processed by event detection module 18 to determine the wellbore pressure 51 at which fracture 5 closes (referred to herein as the “fracture closure pressure”). The fracture closure pressure typically corresponds to the average of minimum principal stress for the area covered by the created fracture 5. In this exemplary embodiment, wellbore pressure 51 indicated in graph 50 shows a steady increase during the pumping phase 52 as injection fluid is continuously injected into the subterranean formation 2 up to a peak of about 27 megapascals (MPa) (3,916 pounds per square inch (psi)) at which point fracture 5 is initiated. Following the creation of fracture 5, wellbore pressure 51 generally declines in the shutdown phase 54 as fluid slowly enters the earthen formation 2 from the wellbore 22 prior to the closure of fracture 5. It may be understood that the wellbore pressure 51 indicated in graph 50 is only exemplary and may deviate substantially from that shown in FIG. 3 depending on the parameters of the given application.

As described above, in this exemplary embodiment, event detection module 18 is configured to detect the closure of fracture 5 including the corresponding fracture closure pressure based on the pressure data (e.g., wellbore pressure 51 of graph 50) captured by the downhole sensor package 44 of downhole assembly 40. Particularly, event detection module 18 is configured to detect the closure of fracture 5 (as well as other subsurface events associated with subsurface region 1) by performing a CWT of the pressure data provided by downhole sensor package 44 so as to tease out, in a manner akin to placing a test subject under a microscope, the closure fracture pressure within the pressure data captured by downhole sensor package 44.

In some embodiments, event detection module 18, in performing the CWT of the pressure data provided by downhole sensor package 44, determines one or more WTCs. In certain embodiments, event detection module 18 additionally determines an energy of the pressure data using the one or more WTCs at a plurality of scales extending within a predefined range. In certain embodiments, event detection module 18 additionally determines the average energy of the pressure data for all of the plurality scales extending within the predefined range. In some embodiments, event detection module 18 further detects the occurrence of a subsurface event (e.g., the closure of fracture 5) based on the average energy of the pressure data.

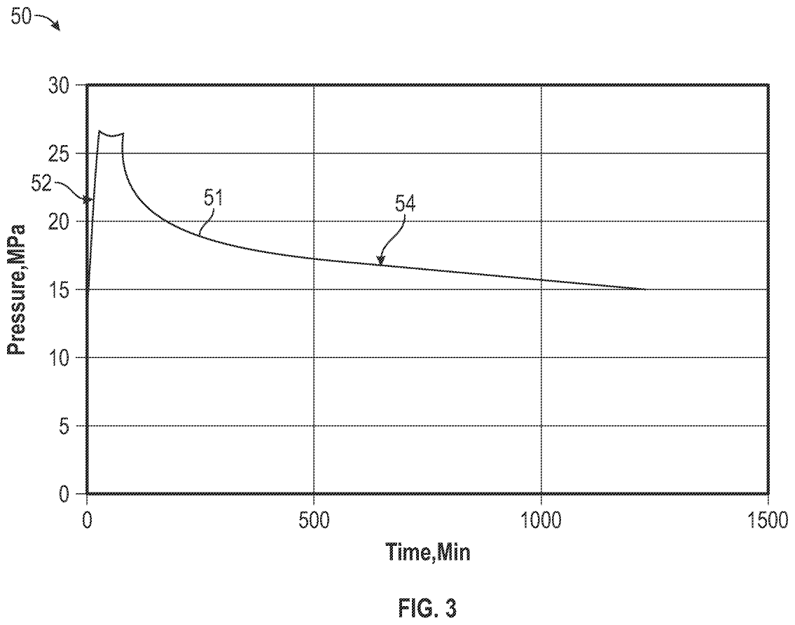

Referring to FIGS. 4-6, a graph 60 depicting the convolution of an exemplary data signal 62 being convolved with a continuous wavelet 65 is shown in FIG. 4. Generally, CWT is a data transformation method that convolves or superimposes a data signal (e.g., pressure data, temperature data, and/or any parameter captured during an event (e.g. DFIT)) with a wavy signal called a “continuous wavelet”. To state in other words, CWT comprises a convolution operation between a wavelet function (e.g., continuous wavelet 65) and the data signal (e.g. data signal 62 of graph 60), which enables localized matching between the wavelet function and the data signal. This convolution can be performed at discrete points via discrete wavelet transform (DWT) or continuously via CWT. The systems and methods described herein (e.g., well system 10, event detection module 18) utilize CWT because, being a continuous rather than a discrete convolution, the performance of CWT is not hindered by data signals having an uneven sampling rate. As an example, sensors deployable into wellbores often have uneven sampling rates given that such sensors (e.g., downhole sensor package 44 shown in FIGS. 1 and 2) are often battery-powered, and uneven sampling is a common technique for maximizing battery life. Generally, discrete convolution requires time-synching the discrete wavelets with the irregularly sampled sensor data, a cumbersome and time-consuming process which beyond being inefficient and costly also makes real-time analysis of the discrete convolutions (e.g., in order to detect a subsurface event) impractical. However, continuous convolutions do not require such time synching and thus irregularly sampled data signals do not present the same limitations as with discrete techniques, thereby permitting the real-time or near real-time analysis of the continuous convolution such as the detection of subsurface events using the continuous convolution (e.g., via the event detection module 18).

Generally, there are two main methods for manipulating continuous wavelets: displacement across the data signal or compression/expansion. Particularly, the continuous wavelet can be manipulated through temporal translation (i.e., moving the wavelet along the time axis as indicated by arrow 61 in FIG. 4). Alternatively, the scale of the continuous wavelet may be stretched or squeezed at a particular point in time.

Not intending to be bound by any particular theory, one or more WTCs (Tc (a, b)) of the convolved data signal and continuous wavelet may be obtained using Equation (1) presented below, where a represents a dilation parameter of the continuous wavelet (defining a scale of the continuous wavelet), b represents a location or translation parameter of the convolution in the time domain, x (t) represents the signal data (e.g., pressure data, temperature data, or any other time series data), t represents time, and

$${ψ}^{*} ( \frac{t - b}{a} )$$

represents the mother wavelet function (e.g., the function defining the given continuous wavelet):

$${T}_{c} ( a , b ) = \frac{1}{\sqrt{a}} {\int }_{- ∞}^{∞} x ( t ) {ψ}^{*} ( \frac{t - b}{a} ) d t \qquad ( 1 )$$

As depicted in FIG. 4, wavelet 65 may be stretched, or compressed, and moved along the data signal 62 comparing each section of the wavelet 65 with the signal 62 such that the wavelet transform is filled with WTCs at different scales and locations. In some embodiments, the WTCs may be squared at the same scales and locations and plotted with the logarithm of the base 2 scale. The resulting WTCs obtained from Equation (1) reflect the level of correlation between the wavelet 65 and the signal 62 at different widths and locations. The scale factor (e.g., parameter a) represents the degree of compression or expansion of the wavelet 65, while the location parameter (e.g., parameter b) indicates where the convolution occurs in the data signal 62. It may be understood that a continuous wavelet is more compressed as the scale factor decreases, acting as a generic microscope to highlight small changes in a respective data signal.

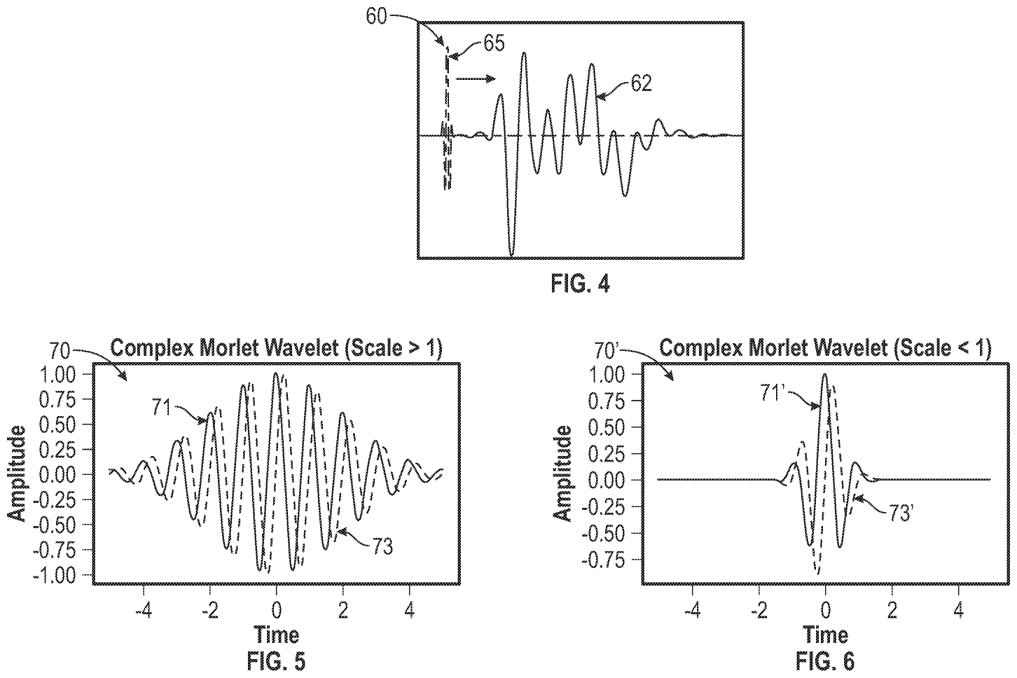

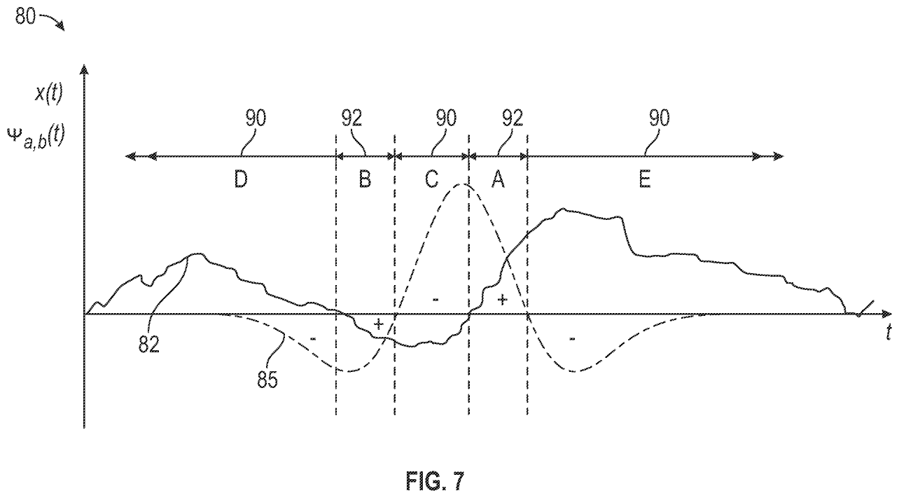

As an example, FIG. 5 shows an initial complex continuous wavelet 70 while FIG. 6 illustrates a version of the same complex continuous wavelet 70′ which has been squeezed at a particular point in time. As discussed above, in some embodiments, complex continuous wavelets which includes real and imaginary parts (e.g., a Morlet wavelet) are used in CWT to detect or monitor subsurface events. In this example, wavelet 70 has a real part 71 and an imaginary part 73. As shown in FIGS. 5 and 6, complex continuous wavelet 70 has a relatively large scale factor (s>1) while complex continuous wavelet 70′ (having real part 71′ and imaginary part 73′) has a relatively small scale factor (0<s<1). Generally, at the large scale of complex continuous wavelet 70, slowly changing details (coarse features) may be detected that cause low frequency in the signal. Conversely, at the small scale of complex continuous wavelet 70′, rapidly changing details (fine features) may be detected that cause high frequency in the signal. Subsurface events may have features of interest at both small and large scales (e.g., low frequency and high frequency features) and thus continuous wavelets of differing scales may be used to analyze subsurface events. For example, and as will be discussed further herein, the respective data signal energy may be converted to average all the scales with time.

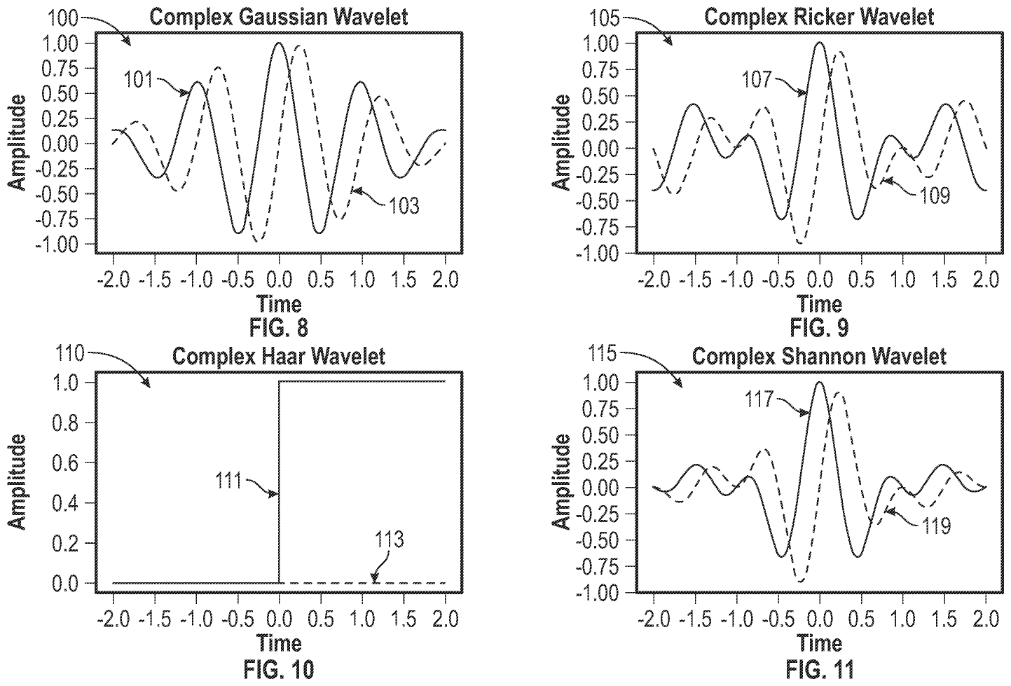

Referring to FIG. 7, another graph 80 depicting the mechanism of convolution of an exemplary data signal 82 with a continuous wavelet 85 is shown. As described above, CWT involves superimposing a continuous wavelet function (e.g., wavelet 85) on an arbitrary signal such as a data signal (e.g., data signal 82). Graph 80 may be broken down into a series of discrete time segments labeled in graph 80 as time segments A-E. Time segments A and B, where both wavelet 85 and data signal 82 agree (are both either positive or negative), result in a large positive WTC due to the positive contribution provided over time segments A and B. On the contrary, in time segments C, D, and E, where the wavelet 85 and the data signal 82 have opposite signs, results in a small WTC due to the negative contribution provided across time segments C, D, and E.

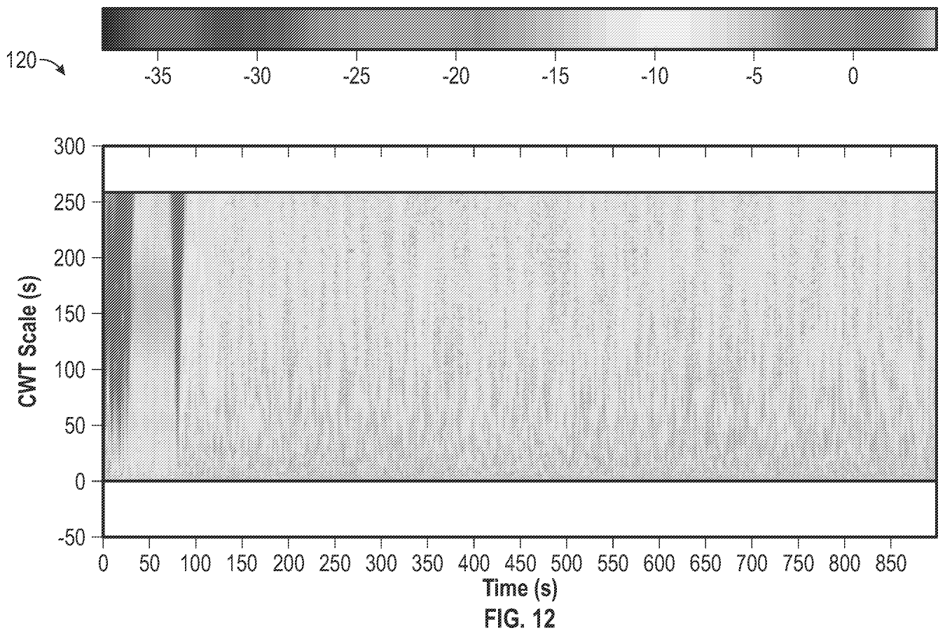

It may be understood that the configuration of the continuous wavelets utilized in the systems and methods described herein (e.g., utilized by the event detection module 18 shown in FIGS. 1 and 2) may vary depending on the given application. Referring briefly to FIGS. 8-11, different embodiments of complex continuous wavelets 100, 105, 110, and 115 are shown. For instance, FIG. 8 depicts a complex Gaussian wavelet 100 (having real part 101 and imaginary part 103); FIG. 9 depicts a complex Ricker wavelet 105 (having real part 107 and imaginary part 109), FIG. 10 depicts a complex Haar wavelet 110 (having real part 111 and imaginary part 113), and FIG. 11 depicts a complex Shannon wavelet 115 (having real part 117 and imaginary part 119). In some embodiments, the choice of wavelet is dictated at least in part by the signal or image characteristics and nature of the application. Additionally, it may be understood that the complex continuous wavelets 100, 105, 110, and 115 illustrate only a non-limiting sample of continuous wavelets which may be utilized by the systems and methods described herein.

In some instances, a complex wavelet may be obtained from a real wavelet by performing a Fourier transform to the real wavelet, and performing an inverse Fourier on the transformed wavelet after neglecting the zero components in the Fourier transform.

As an example, and not intending to be bound by any particular theory, an exemplary complex continuous wavelet (ψ(t)) is defined by Equation (2) presented below, where

$$( \frac{1}{{π}^{\frac{1}{4}}} )$$

represents the normalization factor (e^{l2πf}^{₀}^{t}) represents the complex sinusoid, and

$$( {e}^{\frac{- {t}^{2}}{2}} )$$

represents the Gaussian bell curve:

$$ψ ( t ) = \frac{1}{{π}^{\frac{1}{4}}} {e}^{i 2 π {f}_{0} t} {e}^{\frac{- {t}^{2}}{2}} \qquad ( 2 )$$

In some embodiments, to inspect the multi-scale dimensional characteristics of a data signal using complex wavelets, the WTM of the respective CWT may be determined (e.g., via event detection module 18 shown in FIGS. 1 and 2). Not intending to be bound by any particular theory, the WTM (Tₘ(a, b)) may be obtained using Equation (3) presented below. Generally, WTC is the convolution between the data signal and the complex Morlet wavelet which acts as a mathematical microscope. In at least some embodiments, the result of the convolution is a complex number (e.g., a complex WTC). Generally, the modulus of the WTC is the WTM which represents the real magnitude of the WTC in the real domain.

$${T}_{m} ( a , b ) = \sqrt{[ Re ( T ( a , b ) ) ] + [ Im ( T ( a , b ) ) ]} \qquad ( 3 )$$

It may be understood that underlying system properties associated with a given data signal (e.g., properties of the subterranean formation 2 observable via pressure data captured by the downhole sensor package 44 shown in FIGS. 1 and 2) may be observed and analyzed through an analysis of the signal energy of the data signal. Not intending to be bound by any particular theory, the total energy (E) contained in a respective signal (x(t)) (which is necessarily finite) is defined as its integrated squared magnitude as expressed in Equation (4) below:

$$E = {\int }_{- ∞}^{∞} {\vert x ( t ) \vert}^{2} dt \qquad ( 4 )$$

Not intending to be bound by any particular theory, the relative contribution of the signal energy contained at a specific scale (a) and at a specific location (b) (E(a,b)) is given by the two-dimensional wavelet energy density function as expressed in Equation (5) below:

$$E ( a , b ) = {\vert T ( a , b ) \vert}^{2} \qquad ( 5 )$$

The plot E(a) versus time (different location parameters b values) at different dilation parameter values (scale, a) can be plotted in a plot called a scalogram. The signal energy as a function of both the scale parameter a and the location parameter b may be plotted with respect to time and frequency in a plot known as a scalogram. Scalograms are usually plotted with a logarithm and scale axis. From the scalogram, the location and scale of dominant energetic features within the data signal can be detected from the scale-dependent wavelet energy spectrum of the data signal energy E (a) at specific scales.

Referring now to FIGS. 2 and 12-15, the event detection module 18 of well system 10 may be used to implement CWT to detect and monitor one or more subsurface events associated with subsurface region 1 such as, for example, the closure of fracture 5 shown in FIG. 2. Particularly, the pressure signal captured by downhole sensor assembly 44 during the shutdown phase (e.g., shutdown phase 54 shown in FIG. 3) of an injection test (e.g., a DFIT) may be analyzed by event detection module 18 by implementing CWT using a complex continuous wavelet (e.g., a continuous Morlet wavelet) in order to determine the signal energy of the pressure data signal (e.g., pressure data 51 shown in FIG. 3) at different scales. In some embodiments, event detection module 18 may implement CWT across a plurality of scales within a predefined range. For example, in certain embodiments, event detection module 18 may implement CWT across a plurality of scales within a predefined range extending from 0.1 to 256.

In certain embodiments, after determining the signal energy of the pressure data signal via implementing CWT across a plurality of scales, the closure of fracture 5 may be detected from the signal energy, particularly from the average of all the signal energies at several wavelet scales. Specifically, in this exemplary embodiment, the closure of fracture 5 may be detected from the signal energy by first identifying the peak signal energy representing an initiation of the closure of fracture 5. With the initiation of the closure of fracture 5 identified, a stabilized minimum signal energy following the peak in signal energy may be identified, where stabilized minimum signal energy corresponds to a completion of the closure of fracture 5, where the fracture closure pressure corresponds to the wellbore pressure (e.g., as captured by downhole sensor assembly 44) occurring at the time of completion of the closure of fracture 5. In some embodiments, the peak signal energy and stabilized minimum signal energy each comprise a log signal energy (e.g., are depicted on a log scale).

In some embodiments, the subsurface event may be detected automatically in real-time or near real-time such as by the event detection module 18 shown in FIGS. 1 and 2. In other embodiments, the subsurface event may be detected manually based on information provided by the event detection module 18.

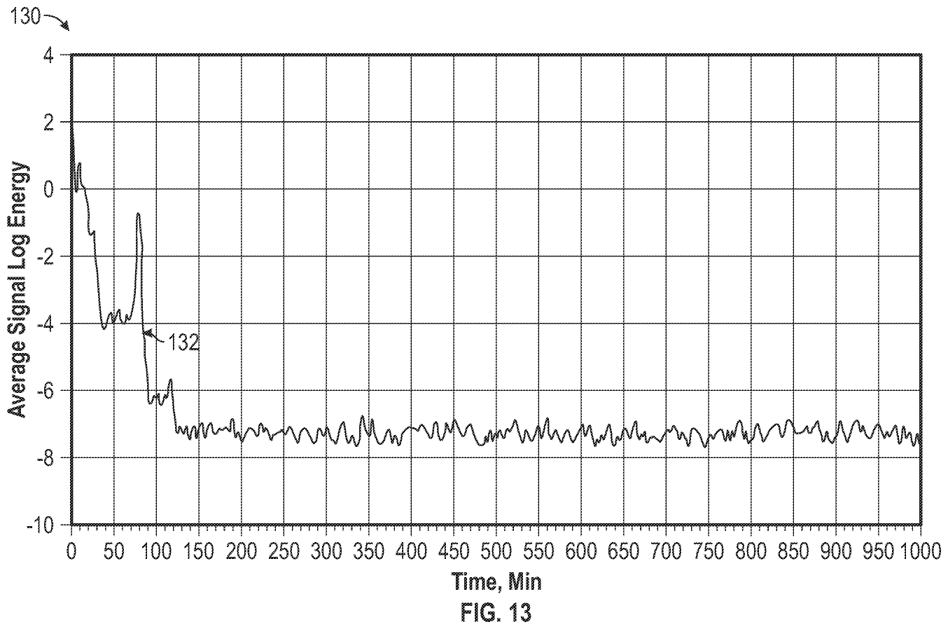

Referring now to FIGS. 12-15, further illustrative examples of detecting subsurface events through implementing CWT are provided. Particularly, in this example, CWT may be implemented (e.g., via event detection module 18 shown in FIGS. 1 and 2) by superimposing a complex continuous wavelet (e.g., a Morlet wavelet) of a data signal (e.g., a pressure data signal, a temperature data signal, a seismic data signal) associated with a subsurface region (e.g., subsurface region 1 shown in FIGS. 1 and 2) to determine one or more WTCs at different scales (for example a from 0.1 to 256) using, for example, Equation (1) presented above. From the WTCs, one or more WTMs may be determined using, for example, Equation (3). An energy signal may be determined from the one or more WTCs and/or the one or more WTMs may be determined using, for example, Equation (5) presented above. The energy signal may be plotted as a function of both time and CWT scale (e.g., parameter a of Equation (1) presented above) via a scalogram.

As an example, an exemplary scalogram 120 is shown in FIG. 12 where the scalogram 120 includes an X-axis depicting time, a Y-axis depicting CWT scale (e.g., parameter a), and the signal energy across time and CWT scales depicted via shading (e.g., in the form of a heatmap). The scalogram of the signal energy may be plotted on a log scale as shown in scalogram 120 of FIG. 12. Additionally, the scalogram 120 is shown with CWT scales extending up to 256. Signal energies can be calculated at different scales from the obtained WTM using Equation (4) presented above. In this manner, the obtained signal energy is determined from the WTM and WTC (e.g., where the WTM is based on the WTC). The signal energy at high CWT scale can be used to detect low frequency features while signal energy at low CWT scale can detect high frequency features. Different features can be detected from the signal energy of the data signal during fracture closure process and even during fracture propagation. For better visualization of the fracture propagation modes, the difference between different signal energies values may be magnified by normalizing the signal energy.

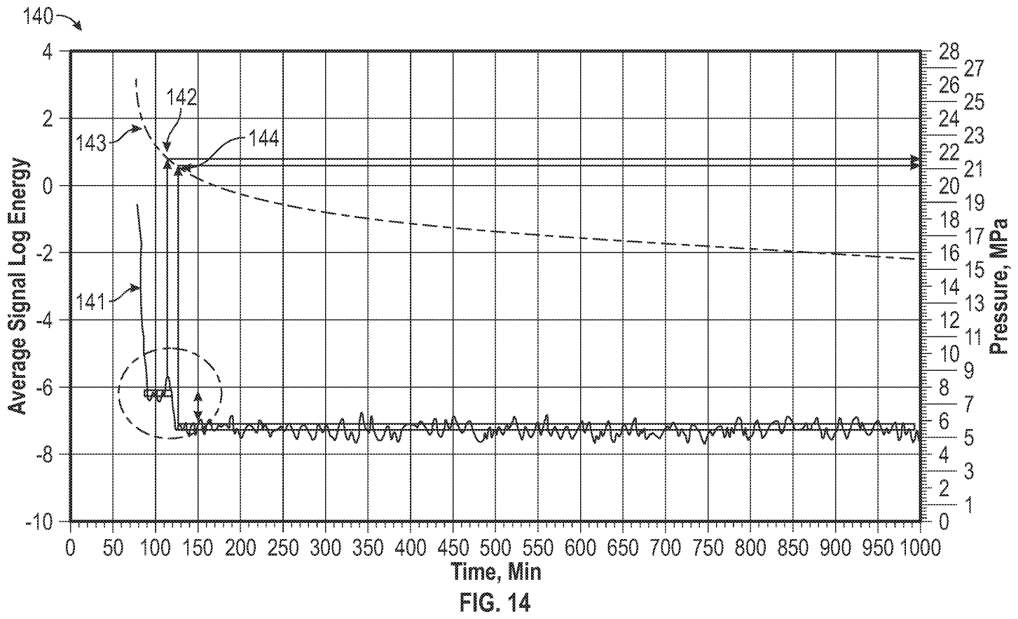

In some embodiments, the energy signal depictable in a scalogram (e.g., scalogram 120) may be averaged across the plurality of CWT scales to determine an average signal energy representable in a 2D graph. Particularly, in some embodiments, the average signal energy may be determined by averaging the log of the signal energy at the same time for each of the plurality of CWT scales. and the resulting average signal log energy may be plotted against time as shown in graph 130 of FIG. 13 which depicts the average signal log energy 132 of the energy signal depicted in scalogram 120. In some embodiments, the one or more CWTs, one or more WTMs, signal energy, average signal log energy, and other parameters are determined in real-time or near real-time by an event detection module such as, for example, the event detection module 18 shown in FIGS. 1 and 2.

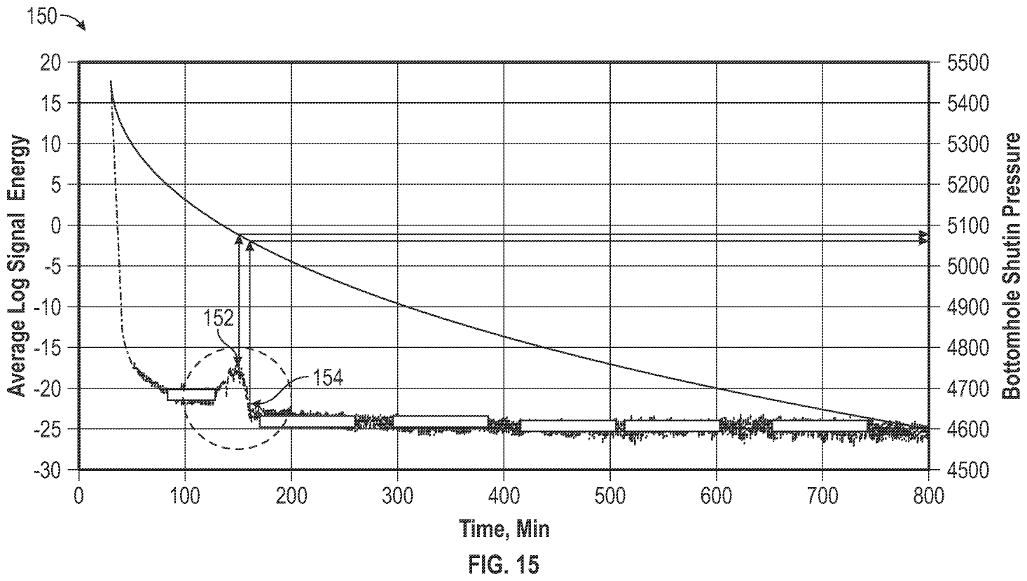

An exemplary graph 140 depicting the average signal log energy 141 (left Y-axis) and bottomhole wellbore pressure 143 (right Y-axis) (e.g., captured by a downhole sensor assembly such as assembly 144 shown in FIGS. 1 and 2) against time (X-axis) is shown in FIG. 14 to further illustrate the detection of the fracture closure pressure. In this example, the initiation of the fracture closure event (approximately 2,760 PSI in graph 140) is identified by the peak 142 in average signal log energy 141, and the fracture closure pressure (approximately 2,700 PSI in graph 140) is identified by the decline in the average signal log energy 141 to a stabilized minimum signal log energy during the shutdown period of an injection test (e.g. DFIT).

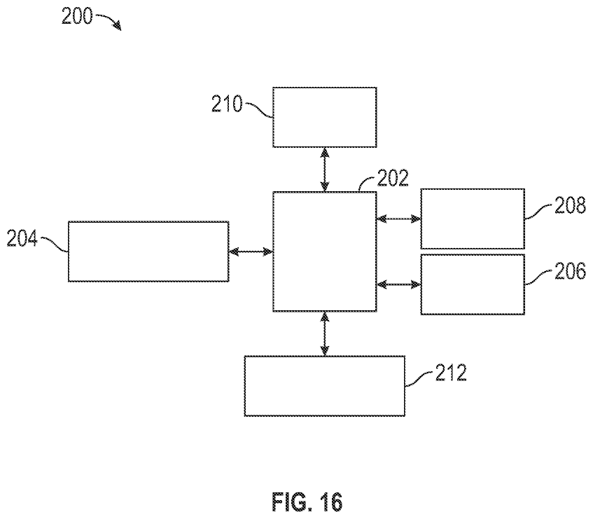

As shown in graph 140 of FIG. 14, there is fluctuation in signal average energy due to noise in real field data. Graph 140 of FIG. 14 shows the actual average signal log energy 141 for a real field pressure data signal (e.g., pressure curve 143). After stopping the injection, the pressure curve 143 shows a continuous decline as fluids leak off from the formation into the fracture. The energy trend in 141 exhibits fluctuations with a consistent pattern during the leak-off process. However, once the pressure within the fracture falls below the minimum horizontal stress (closure pressure), the energy steadily decreases, indicating the onset of fracture closure pressure, as indicated by 142. After the fracture has completely closed, the energy trend tends to stabilize at a lower level, signifying full fracture closure pressure 144. Particularly, fracture faces are not smooth and fracture closure does not occur instantaneously and instead may take up to several minutes to occur. The characteristics of fracture closure as determined through the implementation of CWT can also be seen in graph 150 of FIG. 15. Particularly, graph 150 illustrates the peak in the signal energy level associated with clear difference in signal energy level. In this example, arrow 152 in graph 150 indicates the initiation of fracture closure, and arrow 154 indicates the completion of fracture closure. Thus, the implementation of CWT allows changes in the pressure response from an injection test (e.g. DFIT) to be detected by magnifying the changes that reflect the fracture closure event.

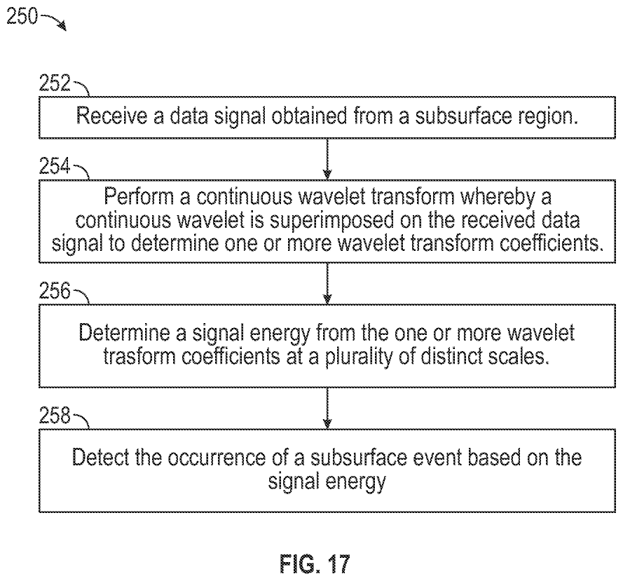

Referring now to FIG. 16, an embodiment of a computer system 200 a suitable for implementing one or more embodiments disclosed herein is shown. For example, the computer system 16 shown in FIGS. 1 and 2 may comprise computer system 200 such that the event detection module 18 of computer system 16 may be executed on or by computer system 200. In this exemplary embodiment, computer system 200 includes a processor 202 (which may be referred to as a central processor unit or CPU) that is in communication with memory devices including secondary storage 204, read only memory (ROM) 206, random access memory (RAM) 208, input/output (I/O) devices 210, and network connectivity devices 212. The processor 202 may be implemented as one or more CPU chips. It is understood that by programming and/or loading executable instructions onto the computer system 200, at least one of the CPU 202, the RAM 208, and the ROM 206 are changed, transforming the computer system 200 in part into a particular machine or apparatus having the novel functionality taught by the present disclosure. Additionally, after the system 200 is turned on or booted, the CPU 202 may execute a computer program or application. For example, the CPU 202 may execute software or firmware stored in the ROM 206 or stored in the RAM 208. In some cases, on boot and/or when the application is initiated, the CPU 202 may copy the application or portions of the application from the secondary storage 204 to the RAM 208 or to memory space within the CPU 202 itself, and the CPU 202 may then execute instructions that the application is comprised of. During execution, an application may load instructions into the CPU 202, for example, load some of the instructions of the application into a cache of the CPU 202. In some contexts, an application that is executed may be said to configure the CPU 202 to do something, e.g., to configure the CPU 202 to perform the function or functions promoted by the subject application. When the CPU 202 is configured in this way by the application, the CPU 202 becomes a specific purpose computer or a specific purpose machine.

Secondary storage 204 may be used to store programs which are loaded into RAM 208 when such programs are selected for execution. The ROM 206 is used to store instructions and perhaps data which are read during program execution. ROM 206 is a non-volatile memory device which typically has a small memory capacity relative to the larger memory capacity of secondary storage 204. The secondary storage 204, the RAM 208, and/or the ROM 206 may be referred to in some contexts as computer readable storage media and/or non-transitory computer readable media. I/O devices 210 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 212 may take the form of modems, modem banks, Ethernet cards, universal serial bus (USB) interface cards, wireless local area network (WLAN) cards, radio transceiver cards, and/or other well-known network devices. The network connectivity devices 212 may provide wired communication links and/or wireless communication links. These network connectivity devices 212 may enable the processor 202 to communicate with the Internet or one or more intranets. With such a network connection, it is contemplated that the processor 202 might receive information from the network, or might output information to the network.

The processor 202 executes instructions, codes, computer programs, scripts which it accesses from hard disk, optical disk, flash drive, ROM 206, RAM 208, or the network connectivity devices 212. While only one processor 202 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 204, for example, hard drives, optical disks, and/or other device, the ROM 206, and/or the RAM 208 may be referred to in some contexts as non-transitory instructions and/or non-transitory information.

In an embodiment, the computer system 200 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

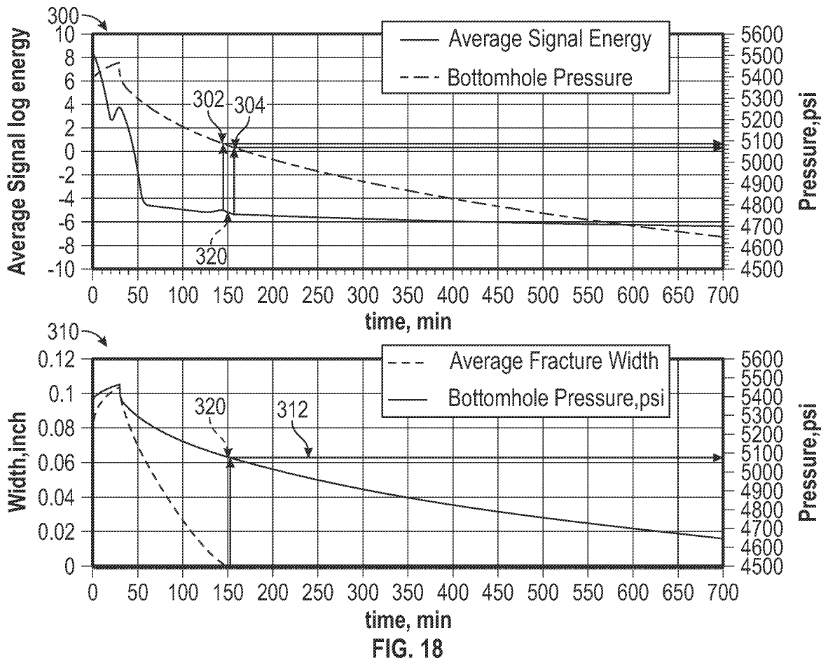

Referring to FIG. 17, an embodiment of a method 250 for monitoring or detecting subsurface events is shown. Beginning at block 252, method 250 includes receiving a data signal (e.g., pressure, temperature or other parameters) obtained from a subsurface region (e.g., subsurface region 1 shown in FIGS. 1 and 2). In some embodiments, the data signal is received during or following an injection test (e.g., a DFIT). At block 254, method 250 comprises performing a continuous wavelet transform whereby a continuous wavelet (e.g., a complex wavelet such as a Morlet wavelet) is superimposed on the received data signal to determine one or more WTCs, In some embodiments, the one or more WTCs are determined at each scale using Equation (1) presented above. In some embodiments, method 250 additionally comprises calculating one or more waveform transform moduli from the one or more WTCs using Equation (3) presented above.

At block 258, a signal energy is determined from the one or more wavelet transform coefficients at a plurality of distinct scales. In some embodiments, the signal energy is determined using Equation (5) presented above. In some embodiments, method 250 additionally includes determining an average of the signal energy for all the plurality of scales extending within a predefined range and plotted against time. The method 250 continues at block 258 by detecting the occurrence of a subsurface event based on the signal energy. In some embodiments, method 250 further includes identifying the fracture closure time from the average signal log energy. In some embodiments, method 250 divides fracture closure identification into two energy characteristics of interest, a peak when the fracture walls come into contact, and a drop-in energy to a minimum stabilized level.

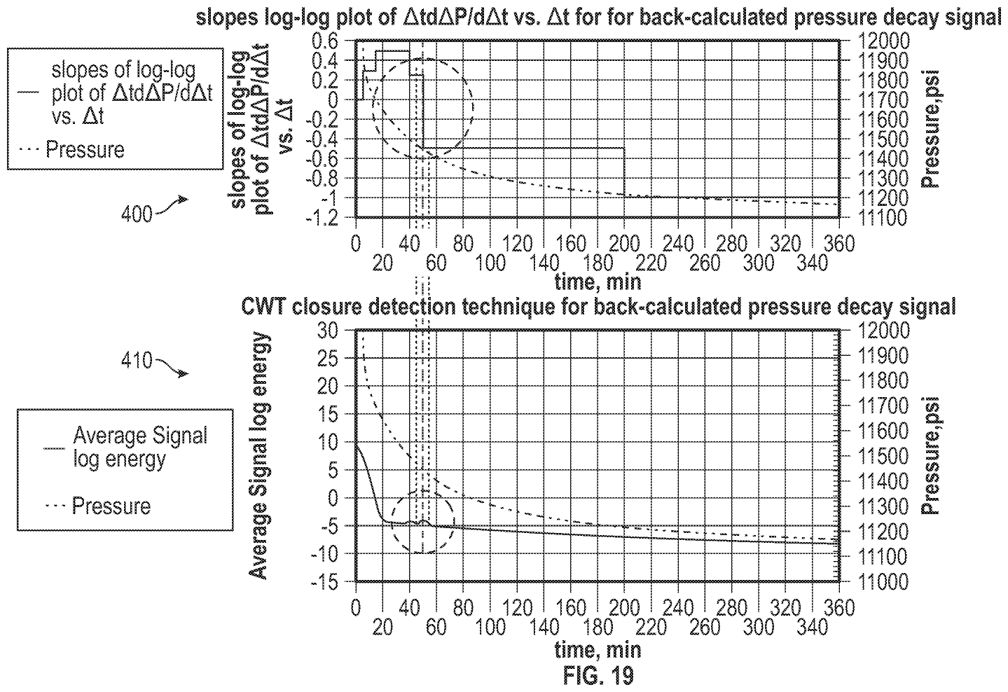

Referring to FIGS. 18 and 19, validation of the systems and methods described herein using synthetic data, flow regime modeling, and strain measurements respectively, are shown. Referring to FIG. 18, graphs 300 and 310 illustrate validation of the CWT technique using a 3D fracture simulator which integrated a finite difference formulation for the fluid flow calculation within a fracture and an integral equation for fracture width. Referring to graph 310, the simulation model using synthetic data showed fracture propagation, then complete fracture closure at minute 153 where the average width was equal to zero, and closure pressure at 5075 psi (indicated by line 312 of graph 310). The pressure from the fracture simulation was analyzed with CWT to detect the average energy over wavelet scales a=512. The signal energy was plotted against time to detect closure as shown in graph 300. The continuous wavelet transform approach showed a pressure of 5095 PSI at start of closure (indicated by line 302 of graph 300), and complete closure pressure of 5075 PSI (indicated by line 304 in graph 300) at about minute 153. The results indicate the same fracture closure pressure with the same time as depicted by 320 in FIG. 18.

Referring now to FIG. 19, graphs 400 and 410 illustrates validation of the CWT technique using flow modeling with a synthetic pressure decay signal that has noise and represents the characteristic flow regimes that happen before and after fracture closure. In this example, the flow regime was identified by the rate of change in pressure with time. In this case, a set of flow regimes were assumed to obtain a synthetic pressure leak-off signal that had a rate change in pressure representing those flow regimes. Then the wavelet transform technique was tested to determine how the CWT closure technique detects the closure. Before closure and after closure flow regimes may be identified using the semi-log pressure derivative on the log-log plot of Δp vs. Δt during the shut-in period following the fracture injection test as shown in graph 400. A pseudo linear flow period was identified by parallel (0.5) slope lines on the log-log Δpwf Δt and Δt dΔp/dδ Δt plot until fracture closure. Bilinear flow may be identified by parallel (0.25) slope lines on log-log Δpwf versus Δt and Δt dΔp/d Δt versus Δt prior to fracture closure). As shown in graphs 400 and 410, the application of the CWT closure technique detected the closure at the same point of the change from the bilinear flow regime to the after-fracture-closure linear flow regime. In addition, the CWT detected the transition period between after closure and before closure accurately.

Table 1 presented below illustrates validation using strain gauge measurement.

TABLE 1

| | E1-I 164 Test 2 | E1-I 164 Test 3 | TV4100 Test 4 | TV4100 Test 7 |
|---|---|---|---|---|
| Fracture closure pressure | 3100 psi | 3100 psi | 2712 psi-2785 psi | 2700 psi |
| using SIMFIP | | | | |
| fracture closure pressure | Start of closure | Start of closure | Start of closure | Start of closure |
| using CWT fracture | 3132 psi | 3000 psi | 2740 psi | 2760 psi |
| closure detection | Complete closure | Complete closure | Complete closure | Complete closure |
| Technique | 3103 psi | 2950 psi | 2700 psi | 2700 psi |
| Fracture closure pressure | Rapid closure | 2725 psi | 2475 psi | 2800 psi |
| using Compliance Method | 3000 psi-3500 psi | | | |
| Fracture closure pressure | Less than | Less than | Less than | 2700 psi |
| using Tangent Method | 2200 psi | 2200 | 2200 psi | |
| Fracture closure pressure | 3400 psi | No closure | 2910 psi | 3177 psi |
| using Nolte Technique | | signature | | |
| Fracture closure pressure | No closure | No closure | No closure | No closure |
| using log-log method | signature | signature | signature | signature |
| Fracture closure pressure | No closure | No closure | No closure | 2700 psi |
| using the square root of | signature | signature | signature | |
| time method | | | | |

A step-rate injection method fracture in-situ properties (SIMFIP) tool was used to validate the CWT technique in this example. The SIMFIP tool was based on a double-packer hydro fracturing probe customized with a 6-component displacement Fiber Bragg grating sensor. A comparison between the compliance, tangent, log-log, and square root of time with the SIMFIP tool reading is shown in Table 1. The CWT fracture closure technique showed the most accurate fracture closure pressure compared with the physical measurement using the SIMFIP tool in the four tests indicated in Table 1.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A computer-implemented method for detecting or monitoring subsurface events, the method comprising:
(a) receiving a data signal obtained from a subsurface region;
(b) performing a continuous wavelet transform whereby a continuous wavelet is superimposed on the received data signal to determine one or more wavelet transform coefficients;
(c) determine a signal energy from the one or more wavelet transform coefficients at a plurality of distinct scales; and
(d) detecting an occurrence of a subsurface event based on the signal energy and the received data signal.

2. The method of claim 1, further comprising:
(e) determining an average signal energy for all of the plurality scales.

3. The method of claim 2, further comprising:
(f) detecting an occurrence of a subsurface event based on the determined average signal energy.

4. The method of claim 1, wherein the plurality of distinct scales of the one or more wavelet transform coefficients is across a predefined range.

5. The method of claim 1, wherein the continuous wavelet comprises a complex wavelet.

6. The method of claim 1, wherein the plurality of distinct scales extends between 0.1 to 256.

7. The method of claim 1, wherein (d) comprises comparing the signal energy with the received data signal.

8. The method of claim 1, wherein (d) comprises identifying a point in time at which the signal energy achieves a stabilized minimum energy level.

9. The method of claim 1, wherein the subsurface event corresponds to a closure of a hydraulic fracture extending from a wellbore penetrating the subsurface region.

10. The method of claim 9, wherein the signal comprises a pressure signal corresponding to a wellbore pressure.

11. The method of claim 1, wherein (b) comprises determining wavelet transform coefficients for all of the plurality scales across a predefined range.

12. The method of claim 1, wherein (d) comprises determining a time at which the subsurface event occurred.

13. The method of claim 1, wherein (d) comprises determining a magnitude of the data signal at a moment in time at which the subsurface event occurred.

14. The method of claim 1, further comprising:
(e) creating a scalogram of the signal energy at the plurality of distinct scales.

15. The method of claim 1, wherein the one or more wavelet transform coefficients determined at (b) are determined in accordance with the following equation where (T(a, d)) represents the continuous wavelet transform, (x(t)) represents the received signal,
$$( {ψ}^{*} ( \frac{t - b}{a} ) )$$
represents a complex mother wavelet function, (t) represents time, (a) represents scale parameter, and (b) represents position parameter:
$$T ( a , b ) = \frac{1}{\sqrt{a}} {\int }_{- ∞}^{∞} x ( t ) {ψ}^{*} ( \frac{t - b}{a} ) dt .$$

16. The method of claim 1, further comprising:
(e) determining one or more wavelet transform moduli from the one or more wavelet transform coefficients; and
(f) determining the signal energy from the one or more wavelet transform moduli.

17. A system for detecting or monitoring subsurface events, the system comprising:
a computer system comprising:
one or more processors; and
one or more memory devices coupled to the one or more processors storing program instructions including an event detection module that, when executed by the one or more processors, cause the one or more processors to:
receive a data signal obtained from a subsurface region;
perform a continuous wavelet transform whereby a continuous wavelet is superimposed on the received signal to determine one or more wavelet transform coefficients;
determine a signal energy from the one or more wavelet transform coefficients at a plurality of distinct scales; and
detect an occurrence of a subsurface event based on the signal energy and the received data signal.

18. (canceled)

19. The system of claim 17, further comprising:
a sensor in signal communication with the event detection module, the sensor configured to produce the data signal received by the event detection module.

20. The system of claim 17, wherein the program instructions including the event detection module, when executed by the one or more processors, cause the one or more processors to:
determine an average signal energy for all of the plurality scales.
